(19) United States
(12) Patent Application Publication
(10) Pub. No.: US 2020/0027364 A1
(43) Pub. Date: Jan. 23, 2020

(54) UTILIZING MACHINE LEARNING MODELS TO AUTOMATICALLY PROVIDE CONNECTED LEARNING SUPPORT AND SERVICES

(71) Applicant: Accenture Global Solutions Limited, Dublin (IE)

(72) Inventors: Inderpreet SINGH, Franklin Park, NJ (US); Mukunda RAM BHUYAN, Bangalore (IN); Sudipta MUKHOPADYAYA, Bangalore (IN); Subhasish ROY, Bangalore (IN)

(21) Appl. No.: 16/435,784

(22) Filed: Jun. 10, 2019

(30) Foreign Application Priority Data
Jul. 18, 2018 (IN) 201841026850

(51) Int. Cl. G09B 5/12; G06N 20/20; G09B 19/06; G06T 19/00

(52) U.S. Cl. CPC G09B 5/12; G06T 19/006; G09B 19/06; G06N 20/20

(57) ABSTRACT

A device receives media data from one or more streaming devices, receives educational data from one or more server devices, and receives Internet of Things (IoT) data from one or more IoT devices. The device pre-processes the media data, the educational data, and the IoT data to generate pre-processed data, and generates one or more machine learning models based on the pre-processed data. The device optimizes parameters for the one or more machine learning models, and validates the one or more machine learning models, based on optimizing the parameters for the one or more machine learning models, to generate one or more validated machine learning models. The device determines, based on the one or more validated machine learning models, recommendations for learning services that are synchronized, and causes at least one of the learning services to be implemented based on the recommendations for the learning services.

### RELATED APPLICATION

This application claims priority under 35 U.S.C. § 119 to Indian Patent Application No. 201841026850, filed on Jul. 18, 2018, and entitled “UTILIZING MACHINE LEARNING MODELS TO AUTOMATICALLY PROVIDE CONNECTED LEARNING SUPPORT AND SERVICES,” the content of which is incorporated by reference herein in its entirety.

### BACKGROUND

Online learning involves courses offered by institutions that may be completely virtual. In the domain of higher education, a learner can engage with an academic institution via a traditional method of brick-and-mortar facilities or via a virtual method through online learning. Learner experience via online learning is typically asynchronous (e.g., without learner interaction), but may also incorporate synchronous elements (e.g., some learner interaction).

### SUMMARY

According to some implementations, a device may include one or more memories, and one or more processors, communicatively coupled to the one or more memories, to receive media data from one or more streaming devices. The one or more processors may receive educational data from one or more server devices, and may receive Internet of Things (IoT) data from one or more IoT devices. The one or more processors may pre-process the media data, the educational data, and the IoT data to generate pre-processed data, and may generate one or more machine learning models based on the pre-processed data. The one or more processors may optimize parameters for the one or more machine learning models, and may validate the one or more machine learning models, based on optimizing the parameters for the one or more machine learning models, to generate one or more validated machine learning models. The one or more processors may determine, based on the one or more validated machine learning models, recommendations for learning services that are synchronized, and may cause at least one of the learning services to be implemented based on the recommendations for the learning services.

According to some implementations, a non-transitory computer-readable medium may store instructions that include one or more instructions that, when executed by one or more processors of a device, cause the one or more processors to receive media data that includes one or more of video streaming data, voice data, or image data. The one or more instructions may cause the one or more processors to receive educational data associated with educational courses and subject matter included in the educational courses, and receive Internet of Things (IoT) data from IoT devices, wherein the IoT data may be associated with the media data and the educational data. The one or more instructions may cause the one or more processors to apply one or more pre-processing techniques to the media data, the educational data, and the IoT data to generate pre-processed data, and generate one or more validated machine learning models based on the pre-processed data. The one or more instructions may cause the one or more processors to utilize the one or more validated machine learning models to determine recommendations for learning services, and cause at least one of the learning services to be implemented based on the recommendations for the learning services.

According to some implementations, a method may include receiving data that includes one or more of media data that includes video streaming data, voice data, or image data, educational data associated with educational courses and subject matter included in the educational courses, or Internet of Things (IoT) data provided by IoT devices. The method may include pre-processing the data to generate pre-processed data, and generating one or more models based on the pre-processed data. The method may include optimizing parameters for the one or more models, and validating the one or more models, based on optimizing the parameters for the one or more models, to generate one or more validated models. The method may include utilizing the one or more validated models to determine recommendations for learning services, and causing at least one of the learning services to be implemented based on the recommendations for the learning services.

### BRIEF DESCRIPTION OF THE DRAWINGS

FIGS. 1A-1J are diagrams of an example implementation described herein.

FIG. 2 is a diagram of an example environment in which systems and/or methods, described herein, may be implemented.

FIG. 3 is a diagram of example components of one or more devices of FIG. 2.

FIGS. 4-6 are flow charts of example processes for utilizing machine learning models to automatically provide connected learning support and services.

### DETAILED DESCRIPTION OF PREFERRED EMBODIMENTS

The following detailed description of example implementations refers to the accompanying drawings. The same reference numbers in different drawings may identify the same or similar elements.

Typical online educational or learning systems provide a single environment (e.g., a virtual environment) which all learners must utilize. However, different learners may require different environments depending on situations of the learners (e.g., access to technology such as virtual reality or augmented reality technology), the subject matter being taught to the learners (e.g., teaching a subject matter that requires hands-on experience, such as marine biology, may require a different environment than a subject matter that does not require hands-on experience, such as mathematics), and/or the like.

Some implementations described herein provide a learning service platform that utilizes machine learning models to automatically provide connected learning support and services. For example, the learning service platform may receive media data from one or more streaming devices, may receive educational data from one or more server devices, and may receive Internet of Things (IoT) data from one or more IoT devices. The learning service platform may pre-process the media data, the educational data, and the IoT data to generate pre-processed data, and may generate one or more machine learning models based on the pre-processed data. The learning service platform may optimize parameters for the one or more machine learning models, and may validate the one or more machine learning models, based on optimizing the parameters for the one or more machine learning models, to generate one or more validated machine learning models. The learning service platform may determine, based on the one or more validated machine learning models, recommendations for learning services that are synchronized, and may cause at least one of the learning services to be implemented based on the recommendations for the learning services.

In this way, the learning service platform may recommend usage of particular devices (e.g., smartphones, tablets, smart glasses, augmented reality devices, virtual reality devices, gaming device, sensors, and/or the like) that provide a unique learning environment that is tailored to each learner. Thus, the learning service platform may decrease the limitation of learning locations, may enable learning to occur on demand and be context-embedded, and may enable learners to take advantage of periods of naturally occurring downtime. The learning platform may provide seamless digital collaboration and communication for the learners.

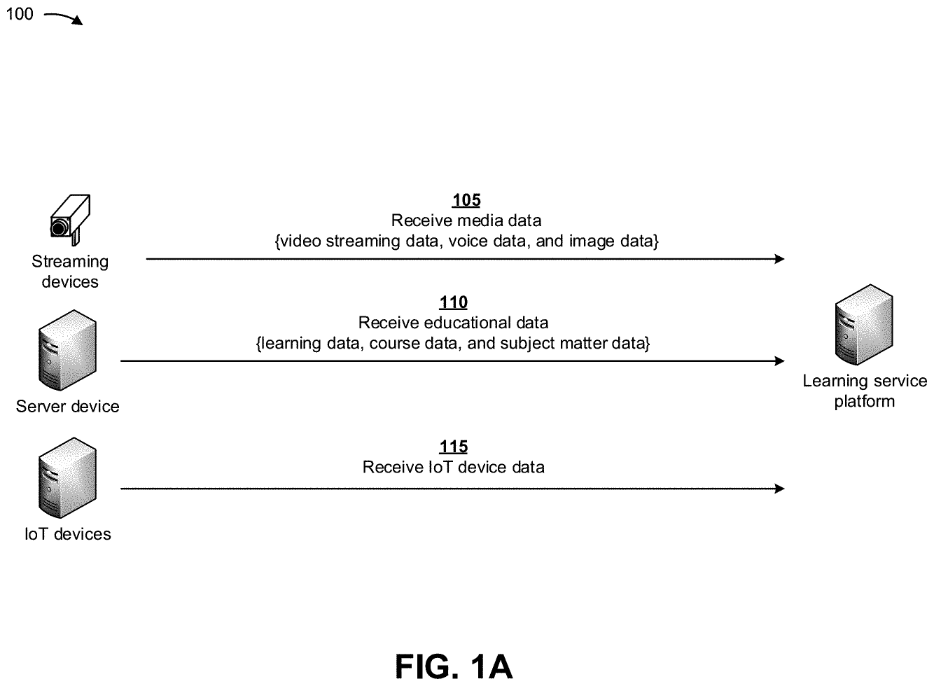

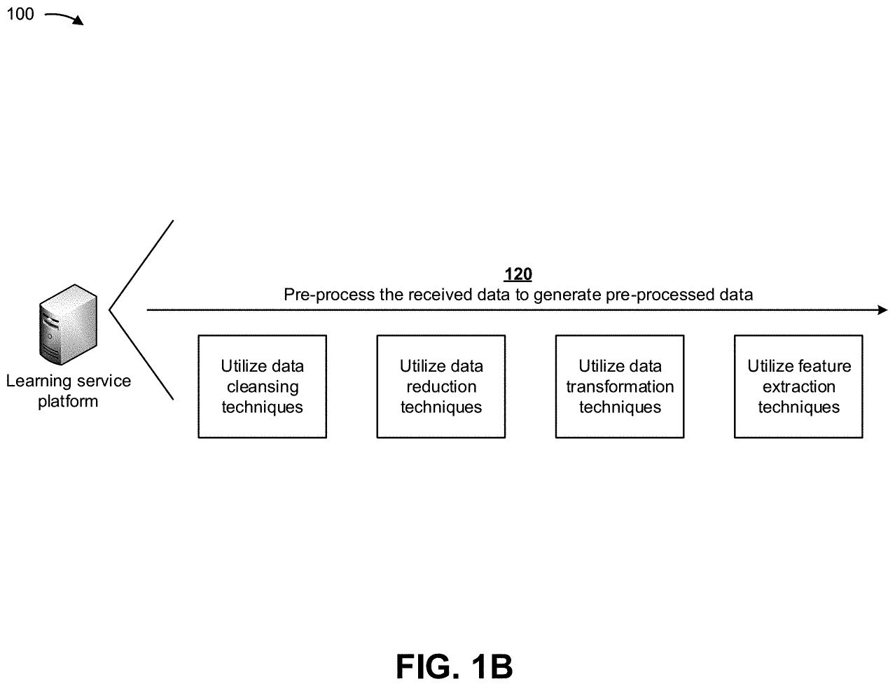

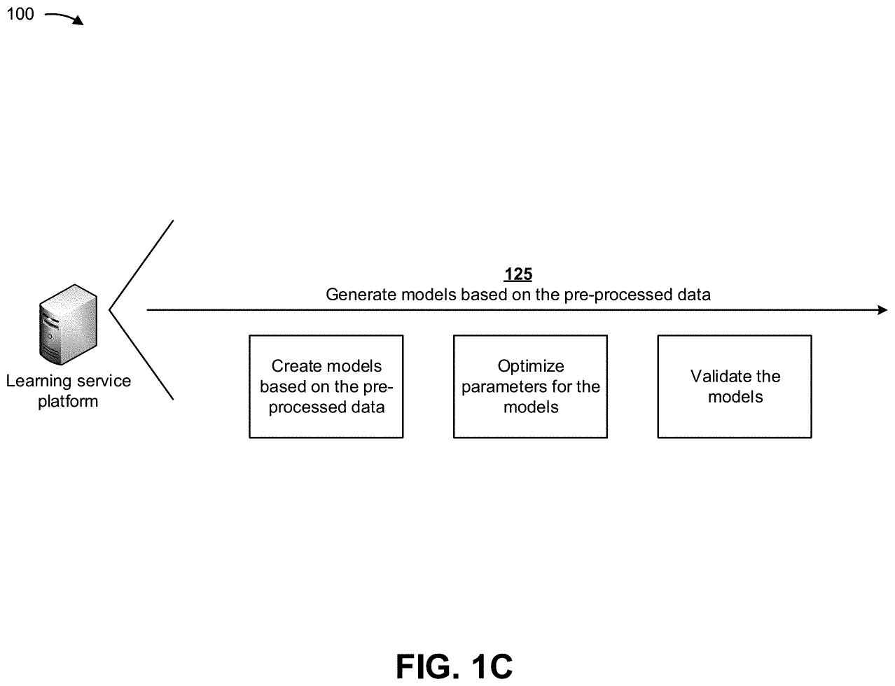

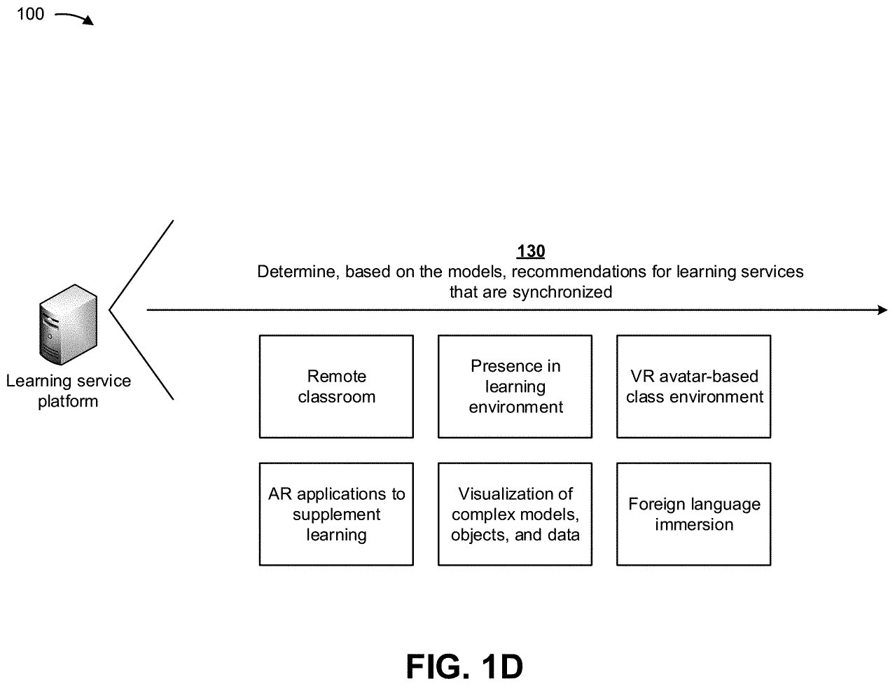

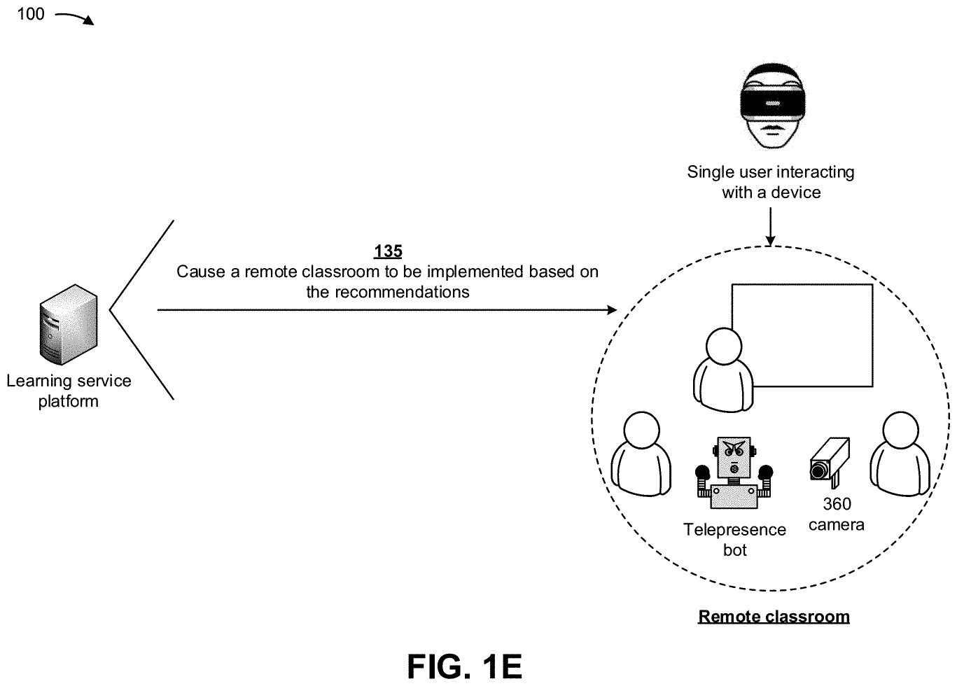

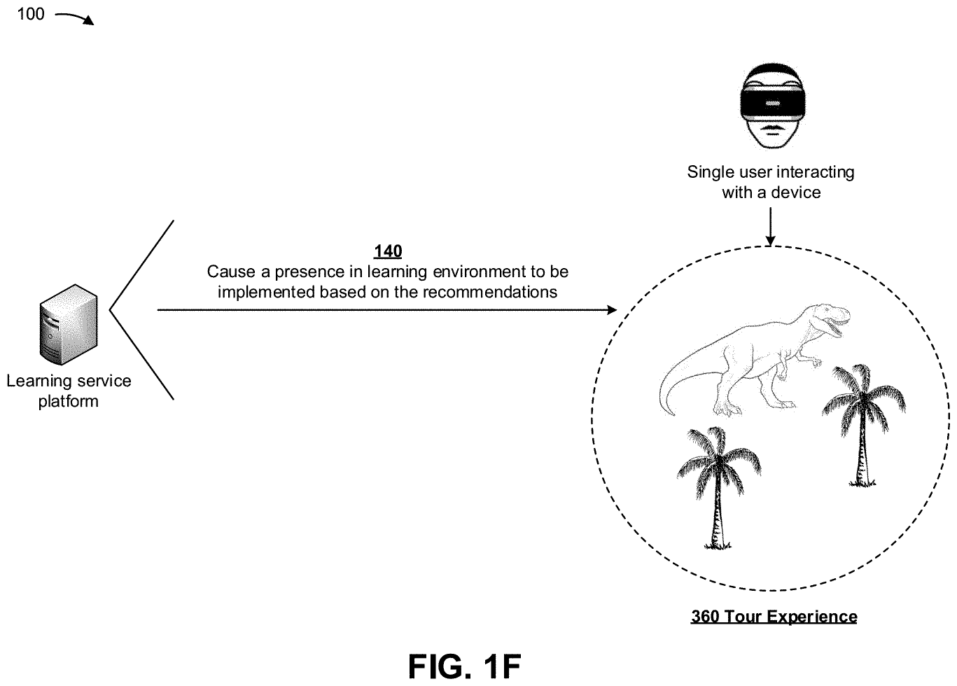

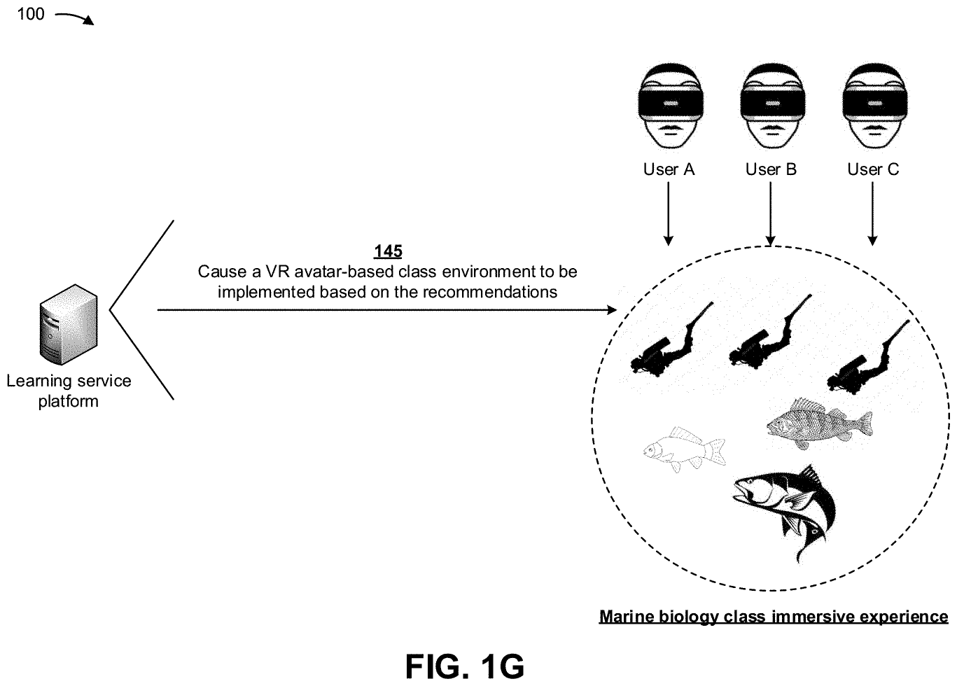

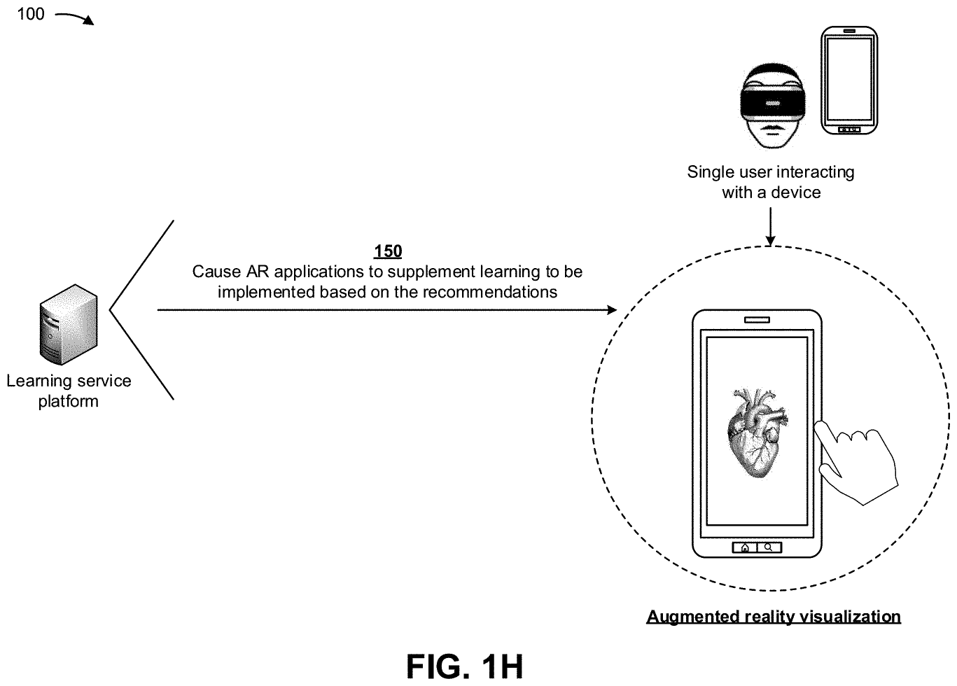

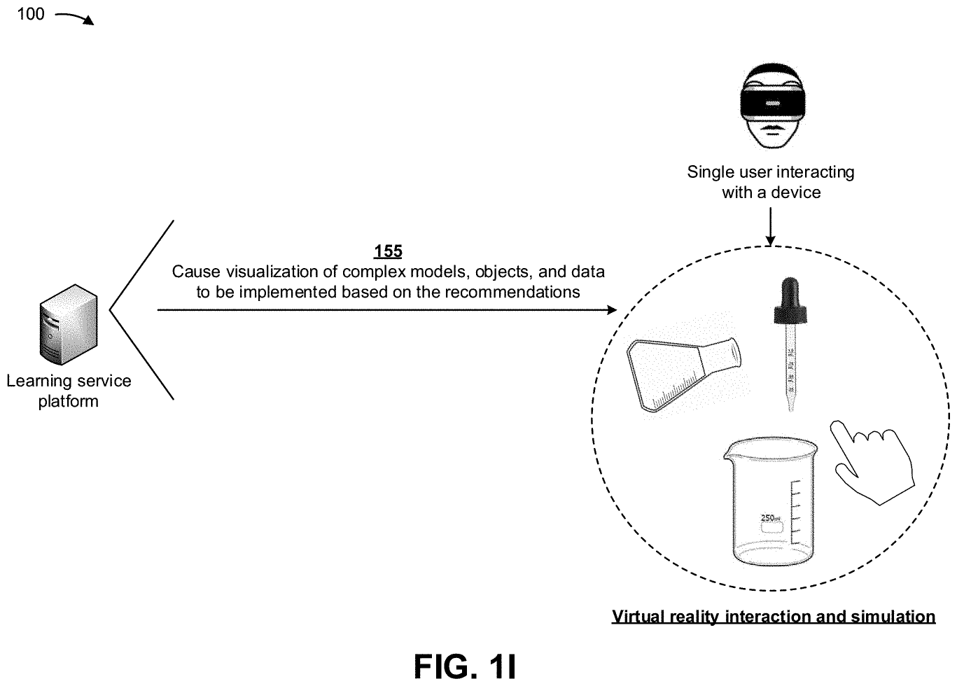

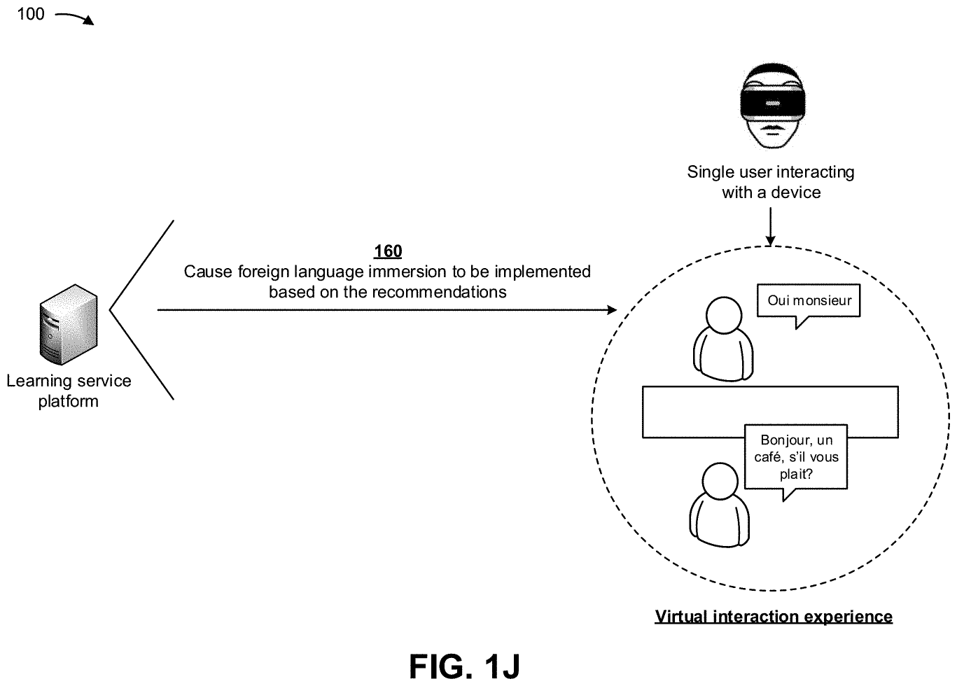

FIGS. 1A-1J are diagrams of an example implementation 100 described herein. As shown in FIG. 1A, streaming devices, a server device, and Internet of Things (IoT) devices may be associated with a learning service platform. In some implementations, the learning service platform may provide different learners with different learning environments, for the same subject matter, based on the situations of the learners, the subject matter being taught, and/or the like. In this way, the learning service platform may provide different learning environments that are synchronized for the same subject matter. In some implementations, the learning service platform may transform a way higher education is received and delivered, and may make higher education more interactive, flexible, efficient, collaborative, and/or the like. In some implementations, the learning service platform may provide digital experiences and services to students with greater sustainability.

As shown in FIG. 1A, and by reference number 105, the learning service platform may receive media data from the streaming devices. In some implementations, the learning platform may store the media data in storage associated with the learning service platform. In some implementations, the media data may include video streaming data (e.g., video received from classes associated with different subjects, video received from learners during online classes associated with the different subjects, video presented in the classes associated with the different subjects, and/or the like), voice data (e.g., voices received from teachers and/or students in the classes associated with the different subjects, voices received from video presented in the classes associated with the different subjects, voices received from learners during online classes associated with the different subjects, and/or the like), image data (e.g., images received from the classes associated with the different subjects, images from the textbooks utilized in the classes, images presented in the classes, images received from learners during online classes associated with the different subjects, and/or the like), and/or the like.

As further shown in FIG. 1A, and by reference number 110, the learning service platform may receive educational data from the server device. In some implementations, the learning service platform may store the educational data in storage associated with the learning service platform. In some implementations, the educational data may include data from a course database (e.g., that includes information about courses or classes associated with different subjects), data associated with the different subjects, textual information included in textbooks utilized in the classes, handouts utilized in the classes, syllabi utilized in the classes, notes memorialized by teachers during the classes, and/or the like.

As further shown in FIG. 1A, and by reference number 115, the learning service platform may receive IoT device data from the IoT devices. In some implementations, the learning service platform may store the IoT device data in storage associated with the learning service platform. In some implementations, the IoT device data may include data from IoT devices (e.g., a whiteboard, a laptop, a video camera, and/or the like) utilized in classes associated with different subjects, data from web-based sites (e.g., associated with textbooks utilized in classes) that incorporate additional videos, materials, animations, assessments, and other materials to aid the learning process, data from educational applications that enable teachers and students to create graphic textbooks which feature videos and provide the capability to take notes, location data from IoT devices (e.g., smartphones utilized by students) that provides an indication of class attendance and eliminates a requirement for taking attendance before every class, data from IoT devices that collect information relevant to the subjects of the classes (e.g., weather patterns can be understood through real-time data from weather sensors all over the globe), and/or the like.

As shown in FIG. 1B, and by reference number 120, the learning service platform may pre-process the received data (e.g., the media data, the educational data, and the IoT device data) to generate pre-processed data. As further shown in FIG. 1B, the learning service platform may utilize one or more pre-processing techniques to pre-process the received data and to generate the pre-processed data, such as data cleansing techniques, data reduction techniques, data transformation techniques, feature extraction techniques, and/or the like. In some implementations, the learning service platform may select the one or more pre-processing techniques based on a variety of factors, such as a type associated with the received data (e.g., video data, image data, audio data such as voice data, IoT device data, and/or the like), whether a source of the received data provides voluminous data that needs to be cleaned and/or reduced in size, whether the received data is provided in a format that requires conversion to a particular format that may be utilized by the learning service platform, and/or the like.

In some implementations, the data cleansing techniques may include techniques that detect and correct (or remove) corrupt or inaccurate records from the received data, and that identify incomplete, incorrect, inaccurate, or irrelevant portions of the received data and replace, modify, or delete the identified portions of the received data. In some implementations, the data reduction techniques may include techniques that transform numerical or alphabetical digital information (e.g., the received data) into a corrected, ordered, and simplified form, and that reduce a quantity of the received data to meaningful parts. For example, when the received data is derived from instrument readings, the data reduction techniques may edit, scale, code, sort, collate, produce tabular summaries, and/or the like from the instrument readings.

In some implementations, the data transformation techniques may include techniques that convert the received data from one format or structure into another format or structure. The data transformation may be simple or complex based on required changes to the received data between the source (initial) data and the target (final) data. In some implementations, the feature extraction techniques may include techniques that start from an initial set of data (e.g., the received data) and create derived values (e.g., features) intended to be informative and non-redundant. The feature extraction techniques may facilitate subsequent learning and generalization, and may lead to improved interpretations.

In some implementations, the learning service platform may pre-process the media data (e.g., a streaming video) by parsing the media data to obtain a streaming topology (e.g., a video streaming topology) for the media data, and identifying frames in the streaming topology. In such implementations, the learning service platform may further pre-process the media data by converting the frames into recommended media data (e.g., in a particular format that is included in the pre-processed data). In some implementations, when parsing the media data (e.g., the streaming video), the learning service platform may parse the streaming video into video packet caches, where each video packet cache includes video frames of a same type. In this way, the learning service platform may more quickly and easily convert the video packet caches into particular formats.

In some implementations, the learning service platform may pre-process the media data (e.g., a streaming video) by performing segmentation and feature extraction on the media data to identify frames in the media data, and by determining relationships between the frames in the media data. In such implementations, the learning service platform may further pre-process the media data by identifying recommended media data (e.g., included in the pre-processed data) based on the relationships between the frames.

In some implementations, the learning service platform may pre-process the received data by determining correlations, general trends, outliers, and/or the like associated with the received data, and by performing an analysis of the received data based on histograms, scatter plots, box plots, and/or the like determined based on the correlations, general trends, outliers, and/or the like associated with the received data. In such implementations, the learning service platform may further pre-process the received data by cleaning the received data based on inconsistent values, duplicate records, invalid entries, and/or the like, by merging duplicate records based on industry-specific domain knowledge, and by transforming and scaling the received data using data manipulation and feature detection.

As shown in FIG. 1C, and by reference number 125, the learning service platform may generate models based on the pre-processed data. In some implementations, the models may include one or more machine learning models (e.g., a support vector machine model, a multivariate decision tree model, a genetic model, a linear regression model, and/or the like), one or more artificial intelligence models (e.g., a Bayesian network model, a deep learning model, a hidden Markov model, and/or the like), and/or the like. In some implementations, the learning service platform may generate the models based on a variety of factors, such as a type associated with the pre-processed data (e.g., video data, image data, audio data, IoT device data, and/or the like), whether the pre-processed data is conducive to machine learning models or artificial intelligence models, a goal of the models (e.g., to identify learning services and/or environments that are synchronized and may be used by a variety of learners), and/or the like. In some implementations, the learning service platform may utilize classification techniques, clustering techniques, and/or decision tree analysis on the pre-processed data to generate the models. For example, the classification techniques may classify the pre-processed data into different classifications (e.g., mathematics, science, philosophy, education, travel, communication, and/or the like. The clustering techniques may organize similar items (e.g., the classified pre-processed data) into groups, and the decision tree analysis may be used to determine connections between the groups.

As further shown in FIG. 1C, when generating the models based on the pre-processed data, the learning service platform may create the models based on the pre-processed data, may optimize parameters for the models (e.g. train the model), and may validate the models based on optimizing the parameters (e.g., based on training the model). In some implementations, the learning service platform may evaluate the models to predict correct results (e.g., results identifying one or more learning services and/or environments that are synchronized and may be used by a variety of learners), and may repeat the aforementioned steps until the models predict the correct results.

In some implementations, the learning service platform may train a model using the pre-processed data (e.g., the pre-processed media data, educational data, and IoT device data), to identify characteristics that automatically identify learning services and/or environments that are synchronized and may be used by a variety of learners. As an example, the learning service platform may determine that pre-processed data, indicating that a particular class is best learned in person, is associated with a threshold likelihood of automatically identifying learning services and/or environments that are synchronized and may be used by a variety of learners. In this case, the learning service platform may determine that a relatively low score (e.g., as being unsuited for automatically identifying learning services and/or environments) is to be assigned to pre-processed data, indicating that a particular class is best learned in person. In contrast, the learning service platform may determine to assign a relatively high score (e.g., as being suited for pre-processed data, indicating that a particular class is best learned in person) to pre-processed data indicating that another particular class may be learned in a variety of ways other than in person.

In some implementations, the learning service platform may perform a training operation (e.g., to optimize the parameters) when generating the models. For example, the learning service platform may portion the pre-processed data into a training set, a validation set, a test set, and/or the like. In some implementations, the learning service platform may train the models using, for example, an unsupervised training procedure and based on the training set of the pre-processed data. For example, the learning service platform may perform dimensionality reduction to reduce the pre-processed data to a minimum feature set, thereby reducing processing to train the models, and may apply a classification technique, to the minimum feature set.

In some implementations, the learning service platform may use a logistic regression classification technique to determine a categorical outcome (e.g., that learning services and/or environments may be automatically identified for a class). Additionally, or alternatively, the learning service platform may use a naive Bayesian classifier technique. In this case, the learning service platform may perform binary recursive partitioning to split the pre-processed data of the minimum feature set into partitions and/or branches, and use the partitions and/or branches to perform predictions (e.g., that learning services and/or environments may be automatically identified for a class). Based on using recursive partitioning, the learning service platform may reduce utilization of computing resources relative to manual, linear sorting and analysis of data points, thereby enabling use of thousands, millions, or billions of data points to train a model, which may result in a more accurate model than using fewer data points.

Additionally, or alternatively, the learning service platform may use a support vector machine (SVM) classifier technique to generate a non-linear boundary between data points in the training set. In this case, the non-linear boundary is used to classify test data into a particular class (e.g., a class indicating that learning services and/or environments may be automatically identified for a class, a class indicating that learning services and/or environments may not be automatically identified for a class, and/or the like).

Additionally, or alternatively, the learning service platform may train the models using a supervised training procedure that includes receiving input to the models from a subject matter expert, which may reduce an amount of time, an amount of processing resources, and/or the like to train the models of activity automatability relative to an unsupervised training procedure. In some implementations, the learning service platform may use one or more other model training techniques, such as a neural network technique, a latent semantic indexing technique, and/or the like. For example, the learning service platform may perform an artificial neural network processing technique (e.g., using a two-layer feedforward neural network architecture, a three-layer feedforward neural network architecture, and/or the like) to perform pattern recognition with regard to patterns of whether learning services and/or environments may or may not be automatically identified for a class. In this case, using the artificial neural network processing technique may improve an accuracy of a model generated by the learning service platform by being more robust to noisy, imprecise, or incomplete data, and by enabling the learning service platform to detect patterns and/or trends undetectable to human analysts or systems using less complex techniques.

In some implementations, the learning service platform may determine a score for each class identified in the educational data. For example, the learning service platform may determine that a mathematics class utilizes a textbook and does not require hands-on learning, that a marine biology class utilizes a textbook with links to web-based videos and requires hands-on learning, and that a robotics class utilizes three-dimensional programming that sometimes requires hands-on learning. In this case, the learning service platform may determine a first score for the mathematics class (e.g., a lower score based on not requiring hands-on learning), a second score for the marine biology class (e.g., a higher score based on requiring hands-on learning), and a third score for the robotics class (e.g., medium score based on utilizing three-dimensional programming).

As shown in FIG. 1D, and by reference number 130, the learning service platform may determine, based on the models, recommendations for learning services (e.g., and/or environments) that are synchronized (e.g., may be used by a variety of different learners utilizing a variety of different computing devices, wearable devices, and/or the like). As further shown in FIG. 1D, the learning service platform may recommend a learning service that provides a remote classroom environment, a learning service that provides a presence in learning environment, a learning service that provides a virtual reality (VR) avatar-based class environment, a learning service that provides augmented reality (AR) applications to supplement learning, a learning service that provides visualization of complex models, objects, and data, a learning service that provides foreign language immersion, and/or the like, described in more detail below.

The remote classroom environment may include an environment that provides a live remote classroom, pre-recorded classes (e.g., higher quality) for offline usage and learning, a utilization of a telepresence bot, and/or the like. The presence in learning environment may include an environment that enables a learner to follow along with instructors in real world environments with panoramic videos (e.g., a geology professor visiting a mine, an operations class touring a factory or a warehouse, a marine biology class exploring ocean life, a history class seeing historical recreations, etc.), provides interactive potential (e.g., pause video motion, present options for quizzes/assessments, integrate with AI feedback, etc.), and/or the like.

The virtual reality (VR) avatar-based class environment may include an environment that provides a recreated learning environment with students represented by avatars, gamification and social and/or collaborative elements, support for academic research (e.g., avatars improving communication), and/or the like. The augmented reality (AR) applications to supplement learning may provide an environment that enables learners to utilize AR applications (e.g., museum view of a sarcophagus, visualization of dinosaurs, and/or the like). The visualization of complex models, objects, and data may include an environment that provides hands-on experience with anatomy, electronic and computer labs, scientific experiments (e.g., simulate dangerous chemistry experiments to reduce real life risk), physics (e.g., gravity simulators), astronomy (e.g., solar system), and/or the like. The foreign language immersion may include an environment that provides interaction with virtual characters, real-time voice-to-text voice processing, and/or the like.

In some implementations, the learning service platform may recommend usage of particular devices (e.g., smartphones, tablets, smart glasses, augmented reality devices, virtual reality devices, gaming device, sensors, and/or the like) that provide a unique learning environment that is tailored to each learner. In such implementations, the learning service platform may receive information about students (e.g., based on the students opting in to providing such information), and may determine (e.g., based on the machine learning models) optimal ways to teach each student. For example, the learning service platform may recommend a first learning service to students that are visual learners, may recommend a second learning service to students that are audible learner, may recommend a third learning service to students that require practicing things, may recommend a fourth learning service to students that are hands-on learners, and/or the like. In such implementations, the information about the students may be obtained based on performance on a variety of tests.

In some implementations, the learning service platform may cause one or more of the learning services to be implemented based on the recommendations for the learning services. In some implementations, the learning service platform may recommend the learning services and/or select the learning services to be implemented based on a variety of factors. For example, the learning service platform may recommend the learning services and/or select the learning services to be implemented based on whether a class and/or a subject requires hands-on learning (e.g., for science labs, history class recreations, and/or the like), technology available to learners (e.g., virtual reality devices, augmented reality devices, telepresence bots, video devices, and/or the like), technology available to an education provider (e.g., telepresence bots, video devices, whiteboards, and/or the like), languages spoken by learners, languages spoken by instructors, and/or the like.

In some implementations, the learning service platform may recommend the learning services and/or select the learning services to be implemented based on a request received from an operator of the learning service platform. For example, an instructor or other individual associated with an educational institution may utilize a user device (e.g., a computer, a tablet device, a laptop computer, and/or the like) to access the learning service platform and to provide, to the learning service platform, a request to recommend learning services for a particular class taught by the instructor. In such an example, the learning service platform may determine, based on the models, recommendations for learning services for the particular class, and may provide information identifying the recommendations to the user device associated with the instructor or the other individual. The learning service platform may also provide, to the user device, instructions indicating how to establish each of the learning services recommended for the particular class.

In some implementations, the learning service platform may automatically recommend the learning services and/or select the learning services to be implemented at a particular time. For example, before a new semester begins for an educational institution, the learning service platform may automatically determine recommendations for learning services (e.g., and/or select the learning services) for the educational institution, and may provide information identifying the recommendations to the education institution. In this way, the learning service platform may enable the educational institution to implement one or more of the recommended learning services before the new semester begins.

In some implementations, the learning service platform may provide a portion of a class utilizing one learning service and may provide another portion of the class utilizing another learning service. For example, if a portion of the class requires lecturing from a textbook, the learning service platform may recommend a remote classroom environment for this portion of the class. However, if another portion the class requires performing experiments in a lab, the learning service platform may recommend the visualization of complex models, objects, and data environment for the other portion of the class.

In some implementations, the learning service platform may provide one learning service to one student and a different learning service to a different student in the same remote classroom based a variety of factors. For example, one factor could be that the one student speaks English as a first language and that the different student speaks Spanish as a first language. In such an example, the learning service platform may provide the same learning service to the two students, but in different languages, or may be teaching the one student in Spanish and teaching the different student the identical lesson in English. Furthermore, the one student may utilize virtual reality, while the different student utilizes augmented reality for the identical lesson.

As shown in FIG. 1E, and by reference number 135, the learning service platform may cause a remote classroom environment to be implemented based on the recommendations. In some implementations, the learning service platform may automatically cause the remote classroom environment to be implemented at a particular time. For example, before a new semester begins for a particular class at an educational institution, the learning service platform may automatically cause the remote classroom environment to be implemented for the particular class, and may provide, to the educational institution, information indicating how to implement the remote classroom environment. In this way, the learning service platform may enable the educational institution to implement the remote classroom environment before the new semester begins.

In some implementations, the remote classroom environment may enable a student to conveniently attend and participate in class from any location at any time. In some implementations, the learning service platform may generate information indicating how to set up the remote classroom environment (e.g., with a telepresence bot, a panoramic (360) video camera, and/or the like), information for presenting subject matter of a class via the remote classroom environment, and/or the like. In some implementations, a remote student (or user) may utilize a device (e.g., a virtual reality device, a tablet computer, and/or the like) to interact with the remote classroom environment. In some implementations, the telepresence bot may enable the student to move and participate in a classroom discussion, and the panoramic camera may create an uninterrupted, self-controlled viewing experience for the student.

In some implementations, the remote classroom environment may not enable the student to move around the classroom. In some implementations, the remote classroom environment may provide a live remote classroom with a fixed camera in a seat (e.g., able to pivot to view classmate attendees, real time benefits from interactivity with the classroom. In some implementations, the remote classroom environment may provide pre-recorded classes that include on-demand availability, incorporation of additional and/or missing information via annotations and comments, and/or the like.

As shown in FIG. 1F, and by reference number 140, the learning service platform may cause a presence in learning environment to be implemented based on the recommendations. In some implementations, the learning service platform may automatically cause the presence in learning environment to be implemented at a particular time. For example, before a new semester begins for a particular class at an educational institution, the learning service platform may automatically cause the presence in learning environment to be implemented for the particular class, and may provide, to the educational institution, information indicating how to implement the presence in learning environment. In this way, the learning service platform may enable the educational institution to implement the presence in learning environment before the new semester begins.

In some implementations, the presence in learning environment may enable a student to travel back to the Jurassic era to tour a prehistoric land in an earth sciences class, take a virtual tour of a factory, and/or the like. In some implementations, the learning service platform may generate information indicating how to set up the presence in learning environment, information for presenting subject matter of a class via the presence in learning environment, and/or the like. In some implementations, a remote student (or user) may utilize a device (e.g., a virtual reality device, a tablet computer, and/or the like) to interact with the presence in learning environment.

In some implementations, the presence in learning environment may provide a point of view perspective that provides a deeper understanding of a subject and improved memory retention (e.g., for those students who learn faster through visual learning techniques), may bring inaccessible experiences to life, and/or the like. In some implementations, the presence in learning environment may enable the student to be present at a mine exploration with a geology professor, at an instructional tour in a factory for an operations class, at marine biology exploration of ocean life, at historical recreations, and/or the like. In some implementations, the presence in learning environment may enable an instructor to control video motion, to present options for quizzes and integrate with AI feedback, to create interactive notes and/or annotations, to zoom in or highlight key objects, and/or the like.

As shown in FIG. 1G, and by reference number 145, the learning service platform may cause a virtual reality avatar-based class environment to be implemented based on the recommendations. In some implementations, the learning service platform may automatically cause the virtual reality avatar-based class environment to be implemented at a particular time. For example, before a new semester begins for a particular class at an educational institution, the learning service platform may automatically cause the virtual reality avatar-based class environment to be implemented for the particular class, and may provide, to the educational institution, information indicating how to implement the virtual reality avatar-based class environment. In this way, the learning service platform may enable the educational institution to implement the virtual reality avatar-based class environment before the new semester begins.

In some implementations, the virtual reality avatar-based class environment may enable students to collaborate in a classroom or a tour outside, in a modeled three-dimensional virtual environment and via avatars (e.g., a marine biology class exploring the ocean). In some implementations, the learning service platform may generate information indicating how to set up the virtual reality avatar-based class environment, information for presenting subject matter of a class via the virtual reality avatar-based class environment, and/or the like. In some implementations, remote students (or users) may utilize devices (e.g., virtual reality devices, tablet computers, and/or the like) to interact with the virtual reality avatar-based class environment.

In some implementations, the virtual reality avatar-based class environment may enhance classroom participation by engaging students in unique hands-on scenarios, may incorporate challenging situations in a virtual environment that teaches students how to collaborate effectively, and/or the like. In some implementations, the virtual reality avatar-based class environment may provide virtual avatars representing student participants, may provide gamification of interactive and collaborative scenarios, and/or the like.

As shown in FIG. 1H, and by reference number 150, the learning service platform may cause augmented reality applications to supplement learning to be implemented based on the recommendations. In some implementations, the learning service platform may automatically cause the augmented reality applications to supplement learning to be implemented at a particular time. For example, before a new semester begins for a particular class at an educational institution, the learning service platform may automatically cause the augmented reality applications to supplement learning to be implemented for the particular class, and may provide, to the educational institution, information indicating how to implement the augmented reality applications to supplement learning. In this way, the learning service platform may enable the educational institution to implement the augmented reality applications to supplement learning before the new semester begins.

In some implementations, the augmented reality applications to supplement learning may enable a student to perform a task that cannot be performed in a real life (e.g., operating a nuclear reactor and simulating situations). In some implementations, the learning service platform may generate information indicating how to set up the augmented reality applications to supplement learning, information for presenting subject matter of a class via the augmented reality applications to supplement learning, and/or the like. In some implementations, a remote student (or user) may utilize a device (e.g., a virtual reality device, a tablet computer, and/or the like) to interact with the augmented reality applications to supplement learning.

In some implementations, the augmented reality applications to supplement learning may provide a simulated environment that allows students to experiment in a controlled situation with limited consequence (e.g., examining human anatomy, performing dangerous experiments, experiencing a gravity simulator, exploring the universe, and/or the like), and may enable students to receive a robust learning experience by engaging multiple human senses (e.g., sight, sound, and simulated touch).

As shown in FIG. 1I, and by reference number 155, the learning service platform may cause visualization of complex models, objects, and data to be implemented based on the recommendations. In some implementations, the learning service platform may automatically cause the visualization of complex models, objects, and data to be implemented at a particular time. For example, before a new semester begins for a particular class at an educational institution, the learning service platform may automatically cause the visualization of complex models, objects, and data to be implemented for the particular class, and may provide, to the educational institution, information indicating how to implement the visualization of complex models, objects, and data. In this way, the learning service platform may enable the educational institution to implement the visualization of complex models, objects, and data before the new semester begins.

In some implementations, the visualization of complex models, objects, and data may enable a student to interact with models, to assemble and/or disassemble an engine to learn how engine works, and/or the like. In some implementations, the learning service platform may generate information indicating how to set up the visualization of complex models, objects, and data, information for presenting subject matter of a class via the visualization of complex models, objects, and data, and/or the like. In some implementations, a remote student (or user) may utilize a device (e.g., a virtual reality device, a tablet computer, and/or the like) to interact with the visualization of complex models, objects, and data.

In some implementations, the visualization of complex models, objects, and data may provide three-dimensional visualization that helps students understand complex concepts, may demonstrate that students' explorative ideas are feasible and not unattainable, may provide for rapid prototyping, may provide three-dimensional renderings of buildings, may provide a microscopic view of microcontrollers, and/or the like.

As shown in FIG. 1 J, and by reference number 160, the learning service platform may cause foreign language immersion to be implemented based on the recommendations. In some implementations, the learning service platform may automatically cause the foreign language immersion to be implemented at a particular time. For example, before a new semester begins for a particular class at an educational institution, the learning service platform may automatically cause the foreign language immersion to be implemented for the particular class, and may provide, to the educational institution, information indicating how to implement the foreign language immersion. In this way, the learning service platform may enable the educational institution to implement the foreign language immersion before the new semester begins.

In some implementations, the foreign language immersion may enable a student to take a language course and conduct a conversation in another language through an avatar. In some implementations, the learning service platform may generate information indicating how to set up the foreign language immersion, information for presenting subject matter of a class via the foreign language immersion, and/or the like. In some implementations, a remote student (or user) may utilize a device (e.g., a virtual reality device, a tablet computer, and/or the like) to interact with the foreign language immersion.

In some implementations, the foreign language immersion may enable students to connect classroom lessons with out-of-classroom use cases, may provide interaction with additional parties that engages a cognitive level of understanding, may enable students to interact with virtual characters in virtual reality, may enable real-time voice-to-text voice processing, and/or the like.

In this way, several different stages of the process for utilizing machine learning models to automatically provide connected learning support and services are automated, which may remove human subjectivity and waste from the process, and which may improve speed and efficiency of the process and conserve computing resources (e.g., processing resources, memory resources, and/or the like). Furthermore, implementations described herein use a rigorous, computerized process to perform tasks or roles that were not previously performed or were previously performed using subjective human intuition or input. For example, currently there does not exist a technique that automatically provides connected learning support and services. Finally, automating the process for utilizing machine learning models to automatically provide connected learning support and services conserves computing resources (e.g., processing resources, memory resources, and/or the like) that would otherwise be wasted in attempting to provide connected learning support and services.

Furthermore, the learning service platform may be used in the context of virtual and connected classroom learning; learning chains; digital interaction, learning, and collaboration; digital support services; virtual and interactive testing, assessment, and certification; personalized always-on learning; academics and student lifecycle management; support services; and/or the like. The learning service platform may be suitable for mobile target audiences that are traditionally difficult to reach, work schedules that do not allow for uninterrupted time for lengthy formal learning on campus, integrated distant and classroom experience, content creation and delivery, staff and student services, and/or the like.

As indicated above, FIGS. 1A-1J are provided merely as examples. Other examples are possible and may differ from what was described with regard to FIGS. 1A-1J.

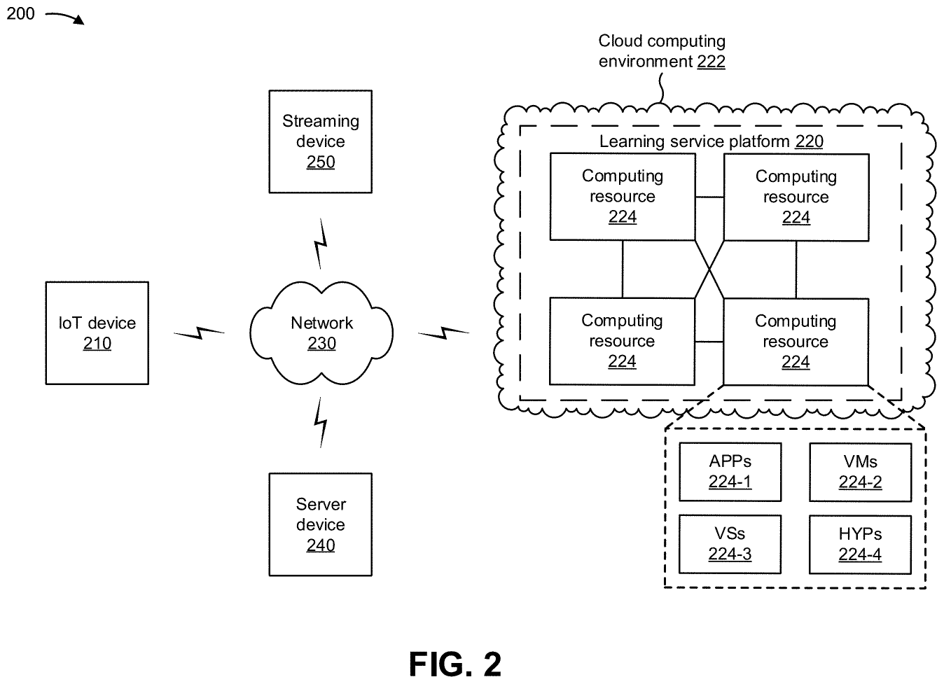

FIG. 2 is a diagram of an example environment 200 in which systems and/or methods, described herein, may be implemented. As shown in FIG. 2, environment 200 may include an IoT device 210, a learning service platform 220, a network 230, a server device 240, and a streaming device. Devices of environment 200 may interconnect via wired connections, wireless connections, or a combination of wired and wireless connections.

IoT device 210 includes one or more devices capable of receiving, generating, storing, processing, and/or providing information, such as information described herein. For example, IoT device 210 may include a physical device (e.g., a sensor, a microphone, a camera, and/or the like), a vehicle, an appliance, and/or the like embedded with electronics, software, sensors, actuators, connectivity, and/or the like, a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. In some implementations, IoT device 210 may receive information from and/or transmit information to learning service platform 220, server device 240, and/or streaming device 250.

Learning service platform 220 includes one or more devices that utilize machine learning models to automatically provide connected learning support and services. In some implementations, learning service platform 220 may be designed to be modular such that certain software components may be swapped in or out depending on a particular need. As such, learning service platform 220 may be easily and/or quickly reconfigured for different uses. In some implementations, learning service platform 220 may receive information from and/or transmit information to one or more IoT devices 210, server devices 240, and/or streaming devices 250.

In some implementations, as shown, learning service platform 220 may be hosted in a cloud computing environment 222. Notably, while implementations described herein describe learning service platform 220 as being hosted in cloud computing environment 222, in some implementations, learning service platform 220 may not be cloud-based (i.e., may be implemented outside of a cloud computing environment) or may be partially cloud-based.

Cloud computing environment 222 includes an environment that hosts learning service platform 220. Cloud computing environment 222 may provide computation, software, data access, storage, etc. services that do not require end-user knowledge of a physical location and configuration of system(s) and/or device(s) that host learning service platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host learning service platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, and/or the like.

Application 224-1 includes one or more software applications that may be provided to or accessed by IoT device 210. Application 224-1 may eliminate a need to install and execute the software applications on IoT device 210. For example, application 224-1 may include software associated with learning service platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., a user of IoT device 210 or an operator of learning service platform 220), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

Server device 240 includes one or more devices capable of receiving, generating, storing, processing, and/or providing information, such as information described herein. For example, server device 240 may include a laptop computer, a tablet computer, a desktop computer, a server device, a group of server devices, or a similar type of device, which provides educational data for access by learning service platform 220. In some implementations, server device 240 may receive information from and/or transmit information to IoT device 210, learning service platform 220, and/or streaming device 250.

Streaming device 250 includes one or more devices capable of receiving, generating, storing, processing, and/or providing information, such as information described herein. For example, streaming device 250 may include a microphone, a video camera, a digital camera, a mobile phone, a laptop computer, a tablet computer, or a similar type of device, which provides media data for access by learning service platform 220. In some implementations, streaming device 250 may receive information from and/or transmit information to IoT device 210, learning service platform 220, and/or server device 240.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

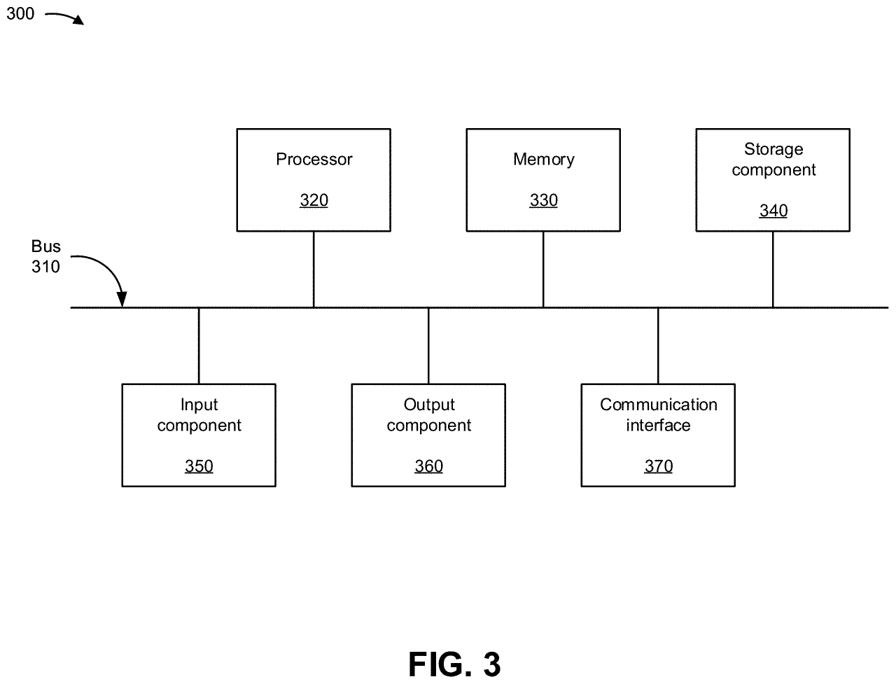

FIG. 3 is a diagram of example components of a device 300. Device 300 may correspond to IoT device 210, learning service platform 220, computing resource 224, server device 240, and/or streaming device 250. In some implementations, us IoT device 210, learning service platform 220, computing resource 224, server device 240, and/or streaming device 250 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, and/or the like.

Device 300 may perform one or more processes described herein. Device 300 may perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

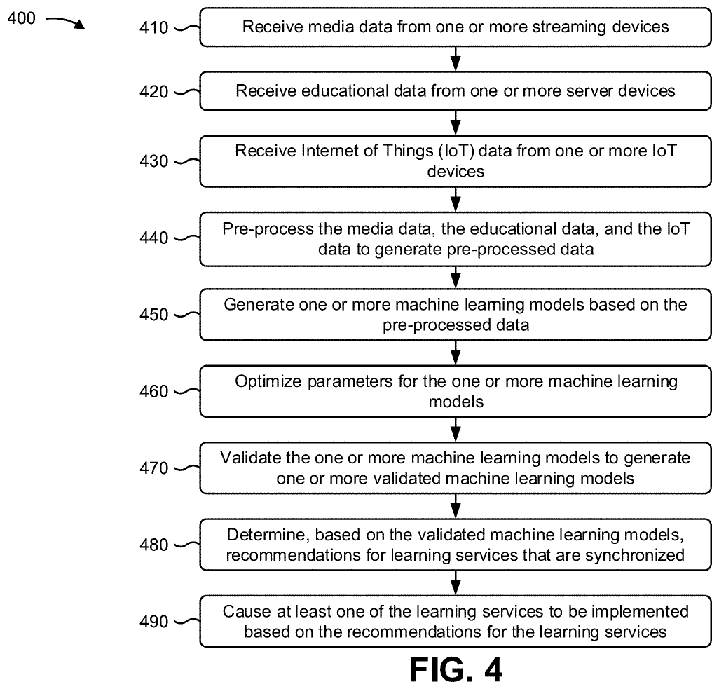

FIG. 4 is a flow chart of an example process 400 for utilizing machine learning models to automatically provide connected learning support and services. In some implementations, one or more process blocks of FIG. 4 may be performed by a learning service platform (e.g., learning service platform 220). In some implementations, one or more process blocks of FIG. 4 may be performed by another device or a group of devices separate from or including the learning service platform, such as an IoT device (e.g., IoT device 210), a server device (e.g., server device 240), and/or a streaming device (e.g., streaming device 250).

As shown in FIG. 4, process 400 may include receiving media data from one or more streaming devices (block 410). For example, the learning service platform (e.g., using computing resource 224, processor 320, communication interface 370, and/or the like) may receive media data from one or more streaming devices, as described above in connection with FIGS. 1A-2.

As further shown in FIG. 4, process 400 may include receiving educational data from one or more server devices (block 420). For example, the learning service platform (e.g., using computing resource 224, processor 320, communication interface 370, and/or the like) may receive educational data from one or more server devices, as described above in connection with FIGS. 1A-2.

As further shown in FIG. 4, process 400 may include receiving Internet of Things (IoT) data from one or more IoT devices (block 430). For example, the learning service platform (e.g., using computing resource 224, processor 320, communication interface 370, and/or the like) may receive Internet of Things (IoT) data from one or more IoT devices, as described above in connection with FIGS. 1A-2.

As further shown in FIG. 4, process 400 may include pre-processing the media data, the educational data, and the IoT data to generate pre-processed data (block 440). For example, the learning service platform (e.g., using computing resource 224, processor 320, memory 330, and/or the like) may pre-process the media data, the educational data, and the IoT data to generate pre-processed data, as described above in connection with FIGS. 1A-2.

As further shown in FIG. 4, process 400 may include generating one or more machine learning models based on the pre-processed data (block 450). For example, the learning service platform (e.g., using computing resource 224, processor 320, memory 330, and/or the like) may generate one or more machine learning models based on the pre-processed data, as described above in connection with FIGS. 1A-2.

As further shown in FIG. 4, process 400 may include optimizing parameters for the one or more machine learning models (block 460). For example, the learning service platform (e.g., using computing resource 224, processor 320, storage component 340, and/or the like) may optimize parameters for the one or more machine learning models, as described above in connection with FIGS. 1A-2.

As further shown in FIG. 4, process 400 may include validating the one or more machine learning models, based on optimizing the parameters for the one or more machine learning models, to generate one or more validated machine learning models (block 470). For example, the learning service platform (e.g., using computing resource 224, processor 320, memory 330, and/or the like) may validate the one or more machine learning models, based on optimizing the parameters for the one or more machine learning models, to generate one or more validated machine learning models, as described above in connection with FIGS. 1A-2.

As further shown in FIG. 4, process 400 may include determining, based on the one or more validated machine learning models, recommendations for learning services that are synchronized (block 480). For example, the learning service platform (e.g., using computing resource 224, processor 320, storage component 340, and/or the like) may determine, based on the one or more validated machine learning models, recommendations for learning services that are synchronized, as described above in connection with FIGS. 1A-2.

As further shown in FIG. 4, process 400 may include causing at least one of the learning services to be implemented based on the recommendations for the learning services (block 490). For example, the learning service platform (e.g., using computing resource 224, processor 320, communication interface 370, and/or the like) may cause at least one of the learning services to be implemented based on the recommendations for the learning services, as described above in connection with FIGS. 1A-2.

Process 400 may include additional implementations, such as any single implementation or any combination of implementations described below and/or described with regard to any other process described herein.

In some implementations, when pre-processing the media data, the educational data, and the IoT data, the learning service platform may apply one or more pre-processing techniques to the media data, the educational data, and the IoT data to generate the pre-processed data, wherein the one or more pre-processing techniques may include one or more of a data cleansing technique, a data reduction technique, a data transformation technique, or a feature extraction technique.

In some implementations, when pre-processing the media data, the learning service platform may parse the media data to obtain a streaming topology for the media data, identify frames in the streaming topology, and convert the frames into recommended media data, wherein the recommended media data may be included in the pre-processed data. In some implementations, when pre-processing the media data, the learning service platform may perform segmentation and feature extraction on the media data to identify frames in the media data, determine relationships between the frames in the media data, and identify recommended media data based on the relationships between the frames, wherein the recommended media data may be included in the pre-processed data.

In some implementations, when generating the one or more machine learning models based on the pre-processed data, the learning service platform may utilize a classification technique, a clustering technique, and a decision tree analysis on the pre-processed data to generate the one or more machine learning models. In some implementations, the one or more machine learning models may include one or more of a support vector machine model, a multivariate decision tree model, a genetic model, or a linear regression model.

In some implementations, the learning services may include one or more of a learning service that provides a remote classroom, a learning service that provides a presence in learning environment, a learning service that provides a virtual reality avatar-based class environment, a learning service that provides augmented reality applications to supplement learning, a learning service that provides visualization of complex models, objects, and data, or a learning service that provides foreign language immersion.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

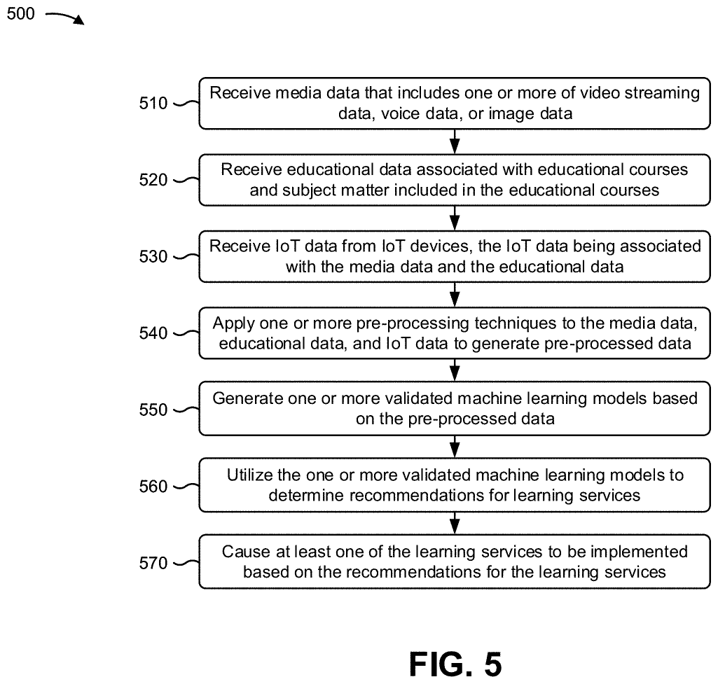

FIG. 5 is a flow chart of an example process 500 for utilizing machine learning models to automatically provide connected learning support and services. In some implementations, one or more process blocks of FIG. 5 may be performed by a learning service platform (e.g., learning service platform 220). In some implementations, one or more process blocks of FIG. 5 may be performed by another device or a group of devices separate from or including the learning service platform, such as an IoT device (e.g., IoT device 210), a server device (e.g., server device 240), and/or a streaming device (e.g., streaming device 250).

As shown in FIG. 5, process 500 may include receiving media data that includes one or more of video streaming data, voice data, or image data (block 510). For example, the learning service platform (e.g., using computing resource 224, communication interface 370, and/or the like) may receive media data that includes one or more of video streaming data, voice data, or image data, as described above in connection with FIGS. 1A-2.

As further shown in FIG. 5, process 500 may include receiving educational data associated with educational courses and subject matter included in the educational courses (block 520). For example, the learning service platform (e.g., using computing resource 224, processor 320, communication interface 370, and/or the like) may receive educational data associated with educational courses and subject matter included in the educational courses, as described above in connection with FIGS. 1A-2.

As further shown in FIG. 5, process 500 may include receiving Internet of Things (IoT) data from IoT devices (block 530). For example, the learning service platform (e.g., using computing resource 224, processor 320, communication interface 370, and/or the like) may receive Internet of Things (IoT) data from IoT devices, as described above in connection with FIGS. 1A-2. In some implementations, the IoT data may be associated with the media data and the educational data.

As further shown in FIG. 5, process 500 may include applying one or more pre-processing techniques to the media data, the educational data, and the IoT data to generate pre-processed data (block 540). For example, the learning service platform (e.g., using computing resource 224, processor 320, storage component 340, and/or the like) may apply one or more pre-processing techniques to the media data, the educational data, and the IoT data to generate pre-processed data, as described above in connection with FIGS. 1A-2.

As further shown in FIG. 5, process 500 may include generating one or more validated machine learning models based on the pre-processed data (block 550). For example, the learning service platform (e.g., using computing resource 224, processor 320, memory 330, and/or the like) may generate one or more validated machine learning models based on the pre-processed data, as described above in connection with FIGS. 1A-2.

As further shown in FIG. 5, process 500 may include utilizing the one or more validated machine learning models to determine recommendations for learning services (block 560). For example, the learning service platform (e.g., using computing resource 224, processor 320, storage component 340, and/or the like) may utilize the one or more validated machine learning models to determine recommendations for learning services, as described above in connection with FIGS. 1A-2.

As further shown in FIG. 5, process 500 may include causing at least one of the learning services to be implemented based on the recommendations for the learning services (block 570). For example, the learning service platform (e.g., using computing resource 224, processor 320, communication interface 370, and/or the like) may cause at least one of the learning services to be implemented based on the recommendations for the learning services, as described above in connection with FIGS. 1A-2.

Process 500 may include additional implementations, such as any single implementation or any combination of implementations described below and/or described with regard to any other process described herein.

In some implementations, when generating the one or more validated machine learning models, the learning service platform may generate one or more machine learning models based on the pre-processed data, optimize parameters for the one or more machine learning models, and validate the one or more machine learning models, based on optimizing the parameters for the one or more machine learning models, to generate the one or more validated machine learning models.

In some implementations, when generating the one or more machine learning models, the learning service platform may utilize one of a classification technique, a clustering technique, or a decision tree analysis on the pre-processed data to generate the one or more machine learning models. In some implementations, the one or more pre-processing techniques may include one or more of a data cleansing technique, a data reduction technique, a data transformation technique, or a feature extraction technique.

In some implementations, the at least one of the learning services may include a learning service that provides one of a remote classroom, a presence in learning environment, a virtual reality avatar-based class environment, augmented reality applications to supplement learning, visualization of complex models, objects, and data, or foreign language immersion. In some implementations, when applying one or more pre-processing techniques to the media data, the learning service platform may parse the media data to obtain a streaming topology for the media data, identify frames in the streaming topology, and convert the frames into recommended media data, wherein the recommended media data may be included in the pre-processed data.

In some implementations, when applying the one or more pre-processing techniques to the media data, the learning service platform may perform segmentation and feature extraction on the media data to identify frames in the media data, determine relationships between the frames in the media data, and identify recommended media data based on the relationships between the frames, wherein the recommended media data may be included in the pre-processed data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

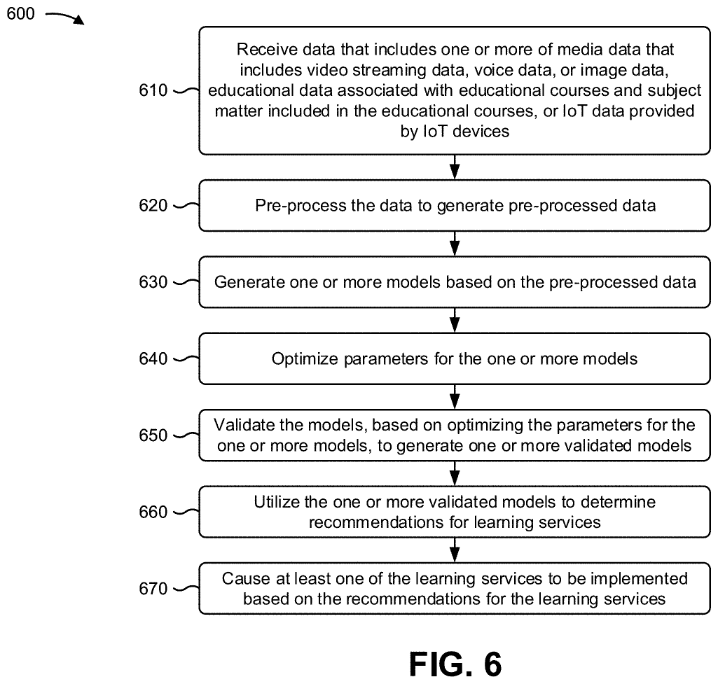

FIG. 6 is a flow chart of an example process 600 for utilizing machine learning models to automatically provide connected learning support and services. In some implementations, one or more process blocks of FIG. 6 may be performed by a learning service platform (e.g., learning service platform 220). In some implementations, one or more process blocks of FIG. 6 may be performed by another device or a group of devices separate from or including the learning service platform, such as an IoT device (e.g., IoT device 210), a server device (e.g., server device 240), and/or a streaming device (e.g., streaming device 250).

As shown in FIG. 6, process 600 may include receiving data that includes one or more of media data that includes video streaming data, voice data, or image data, educational data associated with educational courses and subject matter included in the educational courses, or Internet of Things (IoT) data provided by IoT devices (block 610). For example, the learning service platform (e.g., using computing resource 224, processor 320, communication interface 370, and/or the like) may receive data that includes one or more of media data that includes video streaming data, voice data, or image data, educational data associated with educational courses and subject matter included in the educational courses, or Internet of Things (IoT) data provided by IoT devices, as described above in connection with FIGS. 1A-2.

As further shown in FIG. 6, process 600 may include pre-processing the data to generate pre-processed data (block 620). For example, the learning service platform (e.g., using computing resource 224, processor 320, storage component 340, and/or the like) may pre-process the data to generate pre-processed data, as described above in connection with FIGS. 1A-2.

As further shown in FIG. 6, process 600 may include generating one or more models based on the pre-processed data (block 630). For example, the learning service platform (e.g., using computing resource 224, processor 320, memory 330, and/or the like) may generate one or more models based on the pre-processed data, as described above in connection with FIGS. 1A-2.

As further shown in FIG. 6, process 600 may include optimizing parameters for the one or more models (block 640). For example, the learning service platform (e.g., using computing resource 224, processor 320, storage component 340, and/or the like) may optimize parameters for the one or more models, as described above in connection with FIGS. 1A-2.

As further shown in FIG. 6, process 600 may include validating the one or more models, based on optimizing the parameters for the one or more models, to generate one or more validated models (block 650). For example, the learning service platform (e.g., using computing resource 224, processor 320, memory 330, and/or the like) may validate the one or more models, based on optimizing the parameters for the one or more models, to generate one or more validated models, as described above in connection with FIGS. 1A-2.

As further shown in FIG. 6, process 600 may include utilizing the one or more validated models to determine recommendations for learning services (block 660). For example, the learning service platform (e.g., using computing resource 224, processor 320, memory 330, storage component 340, and/or the like) may utilize the one or more validated models to determine recommendations for learning services, as described above in connection with FIGS. 1A-2.

As further shown in FIG. 6, process 600 may include causing at least one of the learning services to be implemented based on the recommendations for the learning services (block 670). For example, the learning service platform (e.g., using computing resource 224, processor 320, communication interface 370, and/or the like) may cause at least one of the learning services to be implemented based on the recommendations for the learning services, as described above in connection with FIGS. 1A-2.

Process 600 may include additional implementations, such as any single implementation or any combination of implementations described below and/or described with regard to any other process described herein.

In some implementations, the one or more models may include one or more artificial intelligence models, or one or more machine learning models. In some implementations, when pre-processing the data, the learning service platform may apply one or more pre-processing techniques to the data to generate the pre-processed data, where the one or more pre-processing techniques may include one or more of a data cleansing technique, a data reduction technique, a data transformation technique, or a feature extraction technique.

In some implementations, when pre-processing the data, the learning service platform may parse the media data to obtain a streaming topology for the media data, identify frames in the streaming topology, and convert the frames into recommended media data, wherein the recommended media data may be included in the pre-processed data. In some implementations, when pre-processing the data, the learning service platform may perform segmentation and feature extraction on the media data to identify frames in the media data, determine relationships between the frames in the media data, and identify recommended media data based on the relationships between the frames, wherein the recommended media data may be included in the pre-processed data.

In some implementations, when generating the one or more models based on the pre-processed data, the learning service platform may utilize one of a classification technique, a clustering technique, or a decision tree analysis on the pre-processed data to generate the one or more models.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

Some implementations described herein provide a learning service platform that utilizes machine learning models to automatically provide connected learning support and services. For example, the learning service platform may receive media data from one or more streaming devices, may receive educational data from one or more server devices, and may receive Internet of Things (IoT) data from one or more IoT devices. The learning service platform may pre-process the media data, the educational data, and the IoT data to generate pre-processed data, and may generate one or more machine learning models based on the pre-processed data. The learning service platform may optimize parameters for the one or more machine learning models, and may validate the one or more machine learning models, based on optimizing the parameters for the one or more machine learning models, to generate one or more validated machine learning models. The learning service platform may determine, based on the one or more validated machine learning models, recommendations for learning services that are synchronized, and may cause at least one of the learning services to be implemented based on the recommendations for the learning services.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein and/or shown in the figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive media data from one or more streaming devices;
receive educational data from one or more server devices;
receive Internet of Things (IoT) data from one or more IoT devices;
pre-process the media data, the educational data, and the IoT data to generate pre-processed data;
generate one or more machine learning models based on the pre-processed data;
optimize parameters for the one or more machine learning models;
validate the one or more machine learning models, based on optimizing the parameters for the one or more machine learning models, to generate one or more validated machine learning models;
determine, based on the one or more validated machine learning models, recommendations for learning services that are synchronized; and
cause at least one of the learning services to be implemented based on the recommendations for the learning services.

2. The device of claim 1, wherein the one or more processors, when pre-processing the media data, the educational data, and the IoT data, are to:
apply one or more pre-processing techniques to the media data, the educational data, and the IoT data to generate the pre-processed data,
the one or more pre-processing techniques including one or more of:
a data cleansing technique,
a data reduction technique,
a data transformation technique, or
a feature extraction technique.

3. The device of claim 1, wherein the one or more processors, when pre-processing the media data, are to:
parse the media data to obtain a streaming topology for the media data;
identify frames in the streaming topology; and
convert the frames into recommended media data,
the recommended media data being included in the pre-processed data.

4. The device of claim 1, wherein the one or more processors, when pre-processing the media data, are to:
perform segmentation and feature extraction on the media data to identify frames in the media data;
determine relationships between the frames in the media data; and
identify recommended media data based on the relationships between the frames,
the recommended media data being included in the pre-processed data.

5. The device of claim 1, wherein the one or more processors, when generating the one or more machine learning models based on the pre-processed data, are to:
utilize a classification technique, a clustering technique, and a decision tree analysis on the pre-processed data to generate the one or more machine learning models.

6. The device of claim 1, wherein the one or more machine learning models include one or more of:
a support vector machine model,
a multivariate decision tree model,
a genetic model, or
a linear regression model.

7. The device of claim 1, wherein the learning services include one or more of:
a learning service that provides a remote classroom,
a learning service that provides a presence in learning environment,
a learning service that provides a virtual reality avatar-based class environment,
a learning service that provides augmented reality applications to supplement learning,
a learning service that provides visualization of complex models, objects, and data, or
a learning service that provides foreign language immersion.

8. A non-transitory computer-readable medium storing instructions, the instructions comprising:
one or more instructions that, when executed by one or more processors of a device, cause the one or more processors to:
receive media data that includes one or more of video streaming data, voice data, or image data;
receive educational data associated with educational courses and subject matter included in the educational courses;
receive Internet of Things (IoT) data from IoT devices,
the IoT data being associated with the media data and the educational data;
apply one or more pre-processing techniques to the media data, the educational data, and the IoT data to generate pre-processed data;
generate one or more validated machine learning models based on the pre-processed data;
utilize the one or more validated machine learning models to determine recommendations for learning services; and
cause at least one of the learning services to be implemented based on the recommendations for the learning services.

9. The non-transitory computer-readable medium of claim 8, wherein the one or more instructions, that cause the one or more processors to generate the one or more validated machine learning models, cause the one or more processors to:
generate one or more machine learning models based on the pre-processed data;
optimize parameters for the one or more machine learning models; and
validate the one or more machine learning models, based on optimizing the parameters for the one or more machine learning models, to generate the one or more validated machine learning models.

10. The non-transitory computer-readable medium of claim 9, wherein the one or more instructions, that cause the one or more processors to generate the one or more machine learning models, cause the one or more processors to:
utilize one of a classification technique, a clustering technique, or a decision tree analysis on the pre-processed data to generate the one or more machine learning models.

11. The non-transitory computer-readable medium of claim 8, wherein the one or more pre-processing techniques include one or more of:
a data cleansing technique,
a data reduction technique,
a data transformation technique, or
a feature extraction technique.

12. The non-transitory computer-readable medium of claim 8, wherein the at least one of the learning services includes a learning service that provides one of:
a remote classroom,
a presence in learning environment,
a virtual reality avatar-based class environment,
augmented reality applications to supplement learning,
visualization of complex models, objects, and data, or
foreign language immersion.

13. The non-transitory computer-readable medium of claim 8, wherein the one or more instructions, that cause the one or more processors to apply the one or more pre-processing techniques to the media data, cause the one or more processors to:
parse the media data to obtain a streaming topology for the media data;
identify frames in the streaming topology; and
convert the frames into recommended media data,
the recommended media data being included in the pre-processed data.

14. The non-transitory computer-readable medium of claim 8, wherein the one or more instructions, that cause the one or more processors to apply the one or more pre-processing techniques to the media data, cause the one or more processors to:
perform segmentation and feature extraction on the media data to identify frames in the media data;
determine relationships between the frames in the media data; and
identify recommended media data based on the relationships between the frames,
the recommended media data being included in the pre-processed data.

15. A method, comprising:
receiving, by a device, data that includes one or more of:
media data that includes video streaming data, voice data, or image data,
educational data associated with educational courses and subject matter included in the educational courses, or
Internet of Things (IoT) data provided by IoT devices;
pre-processing, by the device, the data to generate pre-processed data;
generating, by the device, one or more models based on the pre-processed data;
optimizing, by the device, parameters for the one or more models;
validating, by the device, the one or more models, based on optimizing the parameters for the one or more models, to generate one or more validated models;
utilizing, by the device, the one or more validated models to determine recommendations for learning services; and
causing, by the device, at least one of the learning services to be implemented based on the recommendations for the learning services.

16. The method of claim 15, wherein the one or more models include:
one or more artificial intelligence models, or
one or more machine learning models.

17. The method of claim 15, wherein pre-processing the data includes:
applying one or more pre-processing techniques to the data to generate the pre-processed data,
the one or more pre-processing techniques including one or more of:
a data cleansing technique,
a data reduction technique,
a data transformation technique, or
a feature extraction technique.

18. The method of claim 15, wherein pre-processing the data includes:
parsing the media data to obtain a streaming topology for the media data;
identifying frames in the streaming topology; and
converting the frames into recommended media data,
the recommended media data being included in the pre-processed data.

19. The method of claim 15, wherein pre-processing the data includes:
performing segmentation and feature extraction on the media data to identify frames in the media data;
determining relationships between the frames in the media data; and
identifying recommended media data based on the relationships between the frames,
the recommended media data being included in the pre-processed data.

20. The method of claim 15, wherein generating the one or more models based on the pre-processed data includes:
utilizing one of a classification technique, a clustering technique, or a decision tree analysis on the pre-processed data to generate the one or more models.
